(19) United States
(12) Patent Application Publication
(10) Pub. No.: US 2017/0357955 A1
(43) Pub. Date: Dec. 14, 2017

(54) METHOD AND SYSTEM FOR LOCAL AND INTERNATIONAL FUNDS TRANSFER

(71) Applicant: MasterCard International Incorporated, Purchase, NY (US)

(72) Inventor: Pravin Parekh, Pune (IN)

(21) Appl. No.: 15/609,333

(22) Filed: May 31, 2017

(30) Foreign Application Priority Data
Jun. 13, 2016 (SG) 10201604809V

(51) Int. Cl. G06Q 20/10

(52) U.S. Cl. CPC G06Q 20/10

(57) ABSTRACT

A method of transferring funds between a user and a beneficiary, the method including, in one or more electronic processing devices: a) receiving a funds transfer request from a client device of the user, the funds transfer request being indicative of: i) user account information indicative of a user account associated with the user; ii) a unique beneficiary identifier issued to the beneficiary by an issuing country; and, iii) an amount of funds to be transferred to the beneficiary; b) determining an indication of the issuing country; c) using the unique beneficiary identifier and indication of the issuing country to retrieve beneficiary account information indicative of a beneficiary account associated with the beneficiary; and, d) causing the funds to be transferred between the user account and the beneficiary account using the user account information and the beneficiary account information.

### CROSS-REFERENCE TO RELATED APPLICATION

This application is a U.S. National Stage filing under 35 U.S.C. §119, based on and claiming benefit of and priority to SG Patent Application No. 10201604809V filed Jun. 13, 2016.

### BACKGROUND OF THE INVENTION

The present invention relates to a method and system for transfer of funds between a user and a beneficiary, including in one or more examples, domestic and international funds transfers or remittances.

### Description of the Prior Art

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Local and international funds transfers or remittances involve an electronic transfer of funds from one person or entity to another. Typically, funds are transferred from a bank account of a user or payer to a bank account of a beneficiary or recipient.

In order to complete a local or international funds transfer between a user and a beneficiary, specific information from the beneficiary of the transfer is required, including for instance:
a) Beneficiary name and address;
b) Full name and address of beneficiary's bank;
c) Beneficiary's account number or International Bank Account Number (IBAN);
d) Beneficiary's bank identifier including for example Society for Worldwide Interbank Financial Telecommunication (SWIFT) or bank identifier code (BIC) code, bank routing number or routing transit number (RTN), Indian Financial Centre Code (IFSC) code; and,
e) Beneficiary's bank branch name, address or number.

At present, around the world there is no standardised user input that needs to be captured to transfer funds to a beneficiary. Different countries and regions have their own requirements for capturing beneficiary details. Typically, a combination of several of the above named beneficiary details are required to be input by a user to enable them to successfully transfer funds from a user bank account to a beneficiary bank account.

For consumers, it is often difficult to remember particular terminologies used in banking (such as SWIFT code, IFSC code, IBAN etc.) and furthermore it can be an onerous task to ascertain all of the necessary details required for a funds transfer to a beneficiary in a particular country. Likewise, it can be equally onerous for the beneficiary who needs to be locate all of the required information to supply to the user to enable them to complete the funds transfer.

If any of the supplied details are incorrect, the transaction will fail which is inconvenient for all parties involved.

It is against this background, and the problems and difficulties associated therewith, that the present invention has been developed.

### SUMMARY OF THE PRESENT INVENTION

In a first aspect, there is provided a method of transferring funds between a user and a beneficiary, the method including, in one or more electronic processing devices: (a) receiving a funds transfer request from a client device of the user, the funds transfer request being indicative of: (i) user account information indicative of a user account associated with the user; (ii) a unique beneficiary identifier, the unique beneficiary identifier being a national identifier issued to the beneficiary by an issuing country; and, (iii) an amount of funds to be transferred to the beneficiary; (b) determining an indication of the issuing country; (c) using the unique beneficiary identifier and indication of the issuing country to retrieve beneficiary account information indicative of a beneficiary account associated with the beneficiary; and, (d) causing the funds to be transferred between the user account and the beneficiary account using the user account information and the beneficiary account information.

It is preferable that the indication of the issuing country is determined from at least one of: (a) a format of the unique beneficiary identifier; and, (b) input received from the user.

Preferably, the one or more electronic processing devices communicate with a format information data store that stores format information indicative of a format of national identifiers associated with a plurality of different issuing countries, and determine the indication of the issuing country associated with the unique beneficiary identifier by comparing the format of the unique beneficiary identifier with the format information.

The method can further include: (a) validating a format of the unique beneficiary identifier using format information determined at least partially in accordance with the indication of the issuing country and, (b) in response to successful validation, retrieving the beneficiary account information. The step of validation can include: (a) using the indication of the issuing country to determine format information indicative of a format of a national identifier associated with the issuing country; and, (b) comparing the determined format information with the format of the unique beneficiary identifier. Preferably, the format information is retrieved from a local format information data store.

It is also preferable that the one or more electronic processing devices use the unique beneficiary identifier to retrieve an associated beneficiary bank identifier from a national identifier data store storing an indication of national identifiers for at least one issuing country. The national identifier data store can be a remote data store. The one or more electronic processing devices can retrieve the beneficiary account information using the unique beneficiary identifier and the beneficiary bank identifier. The beneficiary account information can be retrieved from a bank processing device associated with the beneficiary bank identifier.

The one or more electronic processing devices can: (a) transfer an account information request to the bank processing device using the beneficiary bank identifier, the account information request being indicative of the unique beneficiary identifier; and, (b) receive the beneficiary account information from the bank processing device.

Preferably, the step of causing the funds to be transferred between the user account and the beneficiary account includes providing the user account information and the beneficiary account information to a payment gateway for processing of the funds transfer.

The funds transfer request can be selected by a user from one of: (a) domestic; and, (b) international.

In another aspect, there is provided a method of transferring funds between a user and a beneficiary, the method including, in one or more electronic processing devices: (a) receiving a funds transfer request from a client device of the user, the funds transfer request being indicative of: (i) user account information indicative of a user account associated with the user; (ii) a unique beneficiary identifier, the unique beneficiary identifier being a national identifier issued to the beneficiary by an issuing country; (iii) an issuing country of the unique beneficiary identifier; and, (iv) an amount of funds to be transferred to the beneficiary; (b) validating a format of the unique beneficiary identifier using format information determined at least partially in accordance with an indication of the issuing country; (c) in response to successful validation, using the unique beneficiary identifier to retrieve beneficiary account information indicative of a beneficiary account associated with the beneficiary; and, (d) causing the funds to be transferred between the user account and the beneficiary account using the user account information and the beneficiary account information.

In a further aspect, there is also provided a system for transferring funds between a user and a beneficiary, the system including one or more electronic processing devices that: (a) receive a funds transfer request from a client device of the user, the funds transfer request being indicative of: (i) user account information indicative of a user account associated with the user; (ii) a unique beneficiary identifier, the unique beneficiary identifier being a national identifier issued to the beneficiary by an issuing country; and, (iii) an amount of funds to be transferred to the beneficiary; (b) determine an indication of the issuing country; (c) use the unique beneficiary identifier and indication of the issuing country to retrieve beneficiary account information indicative of a beneficiary account associated with the beneficiary; and, (d) cause the funds to be transferred between the user account and the beneficiary account using the user account information and the beneficiary account information.

Preferably, the one or more electronic processing devices are in communication with one or more of: (a) a local format information data store that stores format information indicative of a format of national identifiers associated with a plurality of different issuing countries; (b) a remote national identifier data store associated with at least one issuing country that stores national identifiers and bank identifier information for a plurality of individuals; and, (c) a bank processing device that stores national identifiers and associated account information for at least some of the plurality of individuals.

The electronic processing device can include a computer-readable storage medium coupled to a processor, the computer-readable storage medium comprising code executable by the processor in the form of applications software.

It will be appreciated that the broad forms of the invention and their respective features can be used in conjunction, interchangeably and/or independently, and reference to separate broad forms in not intended to be limiting.

### BRIEF DESCRIPTION OF THE DRAWINGS

A non-limiting example of the present invention will now be described with reference to the accompanying drawings, in which:

FIG. 1 is a flow chart of an example of a method of transferring funds between a user and a beneficiary;

FIG. 2 is a schematic diagram of an example of a system for transferring funds between a user and a beneficiary;

FIG. 3 is a schematic diagram of an example of payer bank processing device of FIG. 2;

FIG. 4 is a schematic diagram of an example of a client device of FIG. 2;

FIG. 5 is a schematic diagram of an example of a beneficiary bank processing device of FIG. 2;

FIG. 6 is a flow chart of an example of a method for a domestic transfer of funds between a user and a beneficiary;

FIGS. 7A to 7B is a flow chart of an example of a method for an international transfer of funds between a user and a beneficiary;

FIGS. 8A to 8B is a flow chart of an example of a method of validating a format of a unique beneficiary identifier;

FIGS. 9A to 9B is a flow chart of a further example of a method of validating a format of a unique beneficiary identifier;

FIG. 10A is an example of a graphical user interface of an application executing on a client device; and,

FIG. 10B is an example of a system for transferring funds between a user and a beneficiary showing dataflow to and from an application executing on a payer bank processing device.

### DETAILED DESCRIPTION OF THE PREFERRED EMBODIMENTS

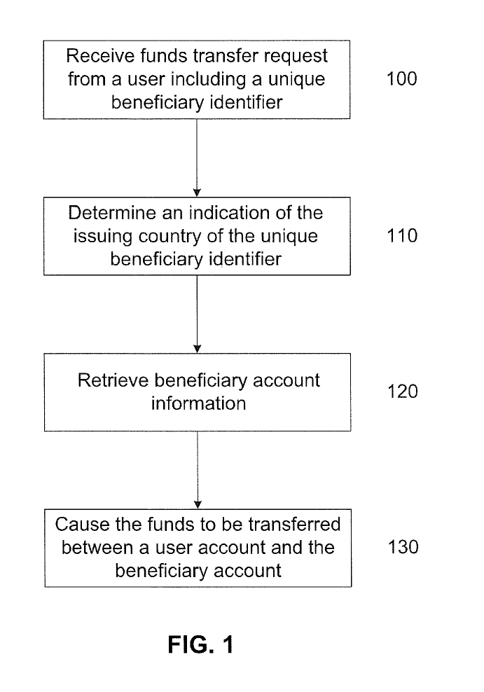

An example of a method of transferring funds between a user and a beneficiary will now be described with reference to FIG. 1.

For the purpose of illustration, it is assumed that the method is performed at least in part using one or more electronic processing devices forming part of one or more processing systems, such as computer systems, servers or the like, which are in turn connected to one or more client devices, such as mobile phones, portable computers, tablet computers, terminals such as automated teller machines (ATMs), or the like, and one or more beneficiary bank processing devices and national identifier data stores via a network architecture, as will be described in more detail below.

The one or more electronic processing devices typically include one or more processing devices associated with a banking or financial institution of the user or payee.

The term “user” is intended to refer to a person or entity wishing to transfer funds to another person or entity and may also be referred to as a payer. The term “beneficiary” refers to a person or entity that is the intended recipient of the funds transfer and may also be referred to as a recipient or payee.

In this example, at step 100 the processing device receives a funds transfer request from a client device of the user. The funds transfer request is typically received via a payment gateway from the client device which may include a mobile device such as a smartphone or tablet, desktop computer, or a terminal such as an ATM or point of sale (POS) device. The funds transfer request is typically received from an application executing on the client device such as a mobile application or digital payment wallet. Alternatively, the request may be made via a webpage displayed on the client device, for example through Internet banking.

The funds transfer request is indicative of user account information indicative of a user account associated with the user, a unique beneficiary identifier, the unique beneficiary identifier being a national identifier issued to the beneficiary by an issuing country, and an amount of funds to be transferred to the beneficiary. The user account information may include for example an indication of the user's name, account number and bank or branch identifier. The unique beneficiary identifier may take any appropriate form and will typically vary between countries depending on the national identifier scheme used by a particular country. The beneficiary identifier will be unique to each individual within an issuing country and therefore provides a unique way of identifying the intended beneficiary of the funds transfer. Typically, the beneficiary identifier will be comprised of alpha-numeric characters, however this is not essential and the identifier could additionally include biometric information such as an image of the beneficiary for example which may be scanned from an identity document such as a passport or drivers license and provided to the user. The beneficiary identifier may also be provided in encoded form, for example being comprised in a QR code or other 2-dimensional barcode.

At step 110, the processing device determines an indication of the issuing country. This may be achieved in several ways depending on what user input has been received. In one example, for at least an international funds transfer, the user may provide an indication of the issuing country for example by entering a country code or other form of country identifier from a list displayed on the client device. In this instance, the processing device simply determines the indication of the issuing country from the user input. In another example, the user may only provide the beneficiary identifier for an international funds transfer. In this instance, the processing device may determine the indication of the issuing country from the format of the beneficiary identifier, as will be described in further detail below. For a domestic funds transfer, the processing device is able to recognise that the beneficiary must be based in the country of origin of the transfer request.

At step 120, the processing device uses the unique beneficiary identifier and indication of the issuing country to retrieve beneficiary account information indicative of a beneficiary account associated with the beneficiary. Typically, the processing device first determines the banking or financial institution associated with the beneficiary from the beneficiary identifier and issuing country, for example by requesting bank identifier information from a country specific national identifier database. Having the bank identifier information and the unique beneficiary identifier, the processing device is able to communicate with the beneficiary bank to retrieve the beneficiary account information.

Finally, at step 130, the processing device causes the funds to be transferred between the user account and the beneficiary account using the user account information and the beneficiary account information. Typically, the processing device provides the user and beneficiary account details to a payment gateway, which then facilitates the transfer in accordance with standard protocols for domestic and international funds transfer/remittance.

Accordingly, it will be appreciated that at least in one example, the above described process provides a number of advantages. A simple and convenient method is provided for transferring funds between a user and a beneficiary. The method provides a standardised input for the user requiring only the unique beneficiary identifier and optionally also an indication of the issuing country of the beneficiary identifier. This significantly simplifies the beneficiary details required to be captured to complete a funds transfer. The user no longer needs to ascertain what the transfer requirements are for different countries and does not need to remember what different terminologies represent (such as Swift code, IBAN, IFSC code, routing numbers etc.). The method also simplifies the process for beneficiaries as they now only need to supply the user with their unique beneficiary number instead of a number of different personal and bank details that have traditionally been required for funds transfers.

By simplifying the funds transfer process, transactions are no longer reliant on so many different details and therefore a user is more likely to enter the required details correctly, leading to fewer failed transactions which is convenient and desirable for all parties involved.

A number of further features will now be described.

In one example, the indication of the issuing country is determined from at least one of, a format of the unique beneficiary identifier or input received from the user. As previously described, and particularly for international funds transfers, the user may have the option or be required to enter a country code or other identifier indicative of the country in which the beneficiary resides, i.e. the issuing country of the unique beneficiary identifier. If user input is received, then the indication of the issuing country is determined from this. Alternatively, if no user input is received then the indication of the issuing country may be determined from the format of the beneficiary identifier. In this regard, the processing device may communicate with a format information data store that stores format information indicative of a format of national identifiers associated with a plurality of different issuing countries. The processing device may then determine the indication of the issuing country associated with the unique beneficiary identifier by comparing the format of the unique beneficiary identifier with the format information.

Typically, the format information is retrieved from a local format information data store in communication with the processing device, however this is not essential and the format information store may be remotely located.

Typically, for an international funds transfer, the user will enter an indication of the issuing country, for example a country code, or the like. In one example, the method further includes validating a format of the unique beneficiary identifier using format information determined at least partially in accordance with the indication of the issuing country and, in response to successful validation, retrieving the beneficiary account information. By validating the beneficiary identifier and country code combination in this way, the processing device can determine whether or not an incorrect country code has been entered or whether or not the format of the beneficiary identifier has been incorrectly entered. This check enables the system to quickly find an error in the funds transfer request which prevents the system from searching for a beneficiary identifier that does not exist or in searching for a beneficiary identifier in the wrong country database.

Typically, the step of validation includes using the indication of the issuing country to determine format information indicative of a format of a national identifier associated with the issuing country, and comparing the determined format information with the format of the unique beneficiary identifier. Examples of algorithms/logic for defining the format of national identifiers include:
China—the ID number has 18 digits and is in the format RRRRRRYYYYMMDDSSSC, where RRRRRR is an address code, YYYYMMDD is a date of birth code, SSS is an order code and C is a checksum;
India—the ID number has 12 digits, the first 11 digits are random and the twelfth digit is a checksum of the preceding 11 digits; and,
Singapore—ID number starts with prefix S (born before 2000) and T (born in or after 2000), followed by a 7 digit number and a checksum alphabet.

If there is no difference between the determined format information and the format of the unique beneficiary identifier then the beneficiary identifier is validated as belonging to the country selected by the user.

Typically, the processing device uses the unique beneficiary identifier to retrieve an associated beneficiary bank identifier from a national identifier data store storing an indication of national identifiers for at least one issuing country. Whilst the national identifier data store is typically country specific, in some examples, the data store may store national identifiers for more than one country. It will be appreciated that the national identifier data store will typically store various personal information related to the identity of an individual including for instance their name, address, date of birth, family and employer details as well as an indication of their bank or financial institution with which they have accounts. For security however, the national identifier data store does not typically store account details of individuals.

Typically, the national identifier data store is a remote data store administered by a government agency or like and which is accessible by the processing device, although this is not essential.

After the beneficiary bank identifier has been determined, the processing device then retrieves the beneficiary account information using the unique beneficiary identifier and the beneficiary bank identifier. Typically, the beneficiary account information is retrieved from a bank processing device such as a bank server associated with the beneficiary bank identifier.

In this regard, the processing device will typically transfer an account information request to the bank processing device using the beneficiary bank identifier, the account information request being indicative of the beneficiary identifier, and receive the beneficiary account information from the bank processing device, which stores (or is in communication with a database server which stores) beneficiary account information for multiple account-holders in association with their respective national identifiers. The beneficiary account information received is typically indicative of bank account details such as a bank account number, branch ID etc. of the beneficiary.

In one example, the step of causing the funds to be transferred between the user account and the beneficiary account includes providing the user account information and the beneficiary account information to a payment gateway for processing of the funds transfer. The payment gateway is responsive to receiving the user account information and beneficiary account information to facilitate the transaction in accordance with standard protocols for both domestic and international funds transfers. The transaction is then processed in accordance with standard protocols and the funds are debited from the user account and credited to the beneficiary account.

Typically, the funds transfer request is selected by a user as being either a domestic (i.e. local) transfer or an international transfer. This is typically achieved by providing the user with a display on their client device which enables them to select the type of transfer they wish to make. In some embodiments the processing device may automatically select the type of transfer based on a determination of the user's country. The determination of the user's country may be made on the basis of the user's geolocation (based on GPS or cell tower location information, or the user's IP address), for example. Alternatively, this information may be retrieved from the user's bank.

In one broad form a method of transferring funds between a user and a beneficiary, includes, in one or more electronic processing devices, receiving a funds transfer request from a client device of the user, the funds transfer request being indicative of user account information indicative of a user account associated with the user, a unique beneficiary identifier, the unique beneficiary identifier being a national identifier issued to the beneficiary by an issuing country, an issuing country of the unique beneficiary identifier; and an amount of funds to be transferred to the beneficiary. The method further includes validating a format of the unique beneficiary identifier using format information determined at least partially in accordance with an indication of the issuing country. In response to successful validation, the method further includes using the unique beneficiary identifier to retrieve beneficiary account information indicative of a beneficiary account associated with the beneficiary; and causing the funds to be transferred between the user account and the beneficiary account using the user account information and the beneficiary account information.

In one broad form a system for transferring funds between a user and a beneficiary is provided, the system including one or more electronic processing devices that receive a funds transfer request from a client device of the user, the funds transfer request being indicative of user account information indicative of a user account associated with the user, a unique beneficiary identifier, the unique beneficiary identifier being a national identifier issued to the beneficiary by an issuing country, and an amount of funds to be transferred to the beneficiary. The one or more electronic processing devices are further configured to determine an indication of the issuing country, use the unique beneficiary identifier and indication of the issuing country to retrieve beneficiary account information indicative of a beneficiary account associated with the beneficiary, and cause the funds to be transferred between the user account and the beneficiary account using the user account information and the beneficiary account information.

Typically, the one or more electronic processing devices are in communication with one or more of a local format information data store that stores format information indicative of a format of national identifiers associated with a plurality of different issuing countries, a remote national identifier data store associated with at least one issuing country that stores national identifiers and bank identifier information for a plurality of individuals, and a bank processing device that stores national identifiers and associated account information for at least some of the plurality of individuals.

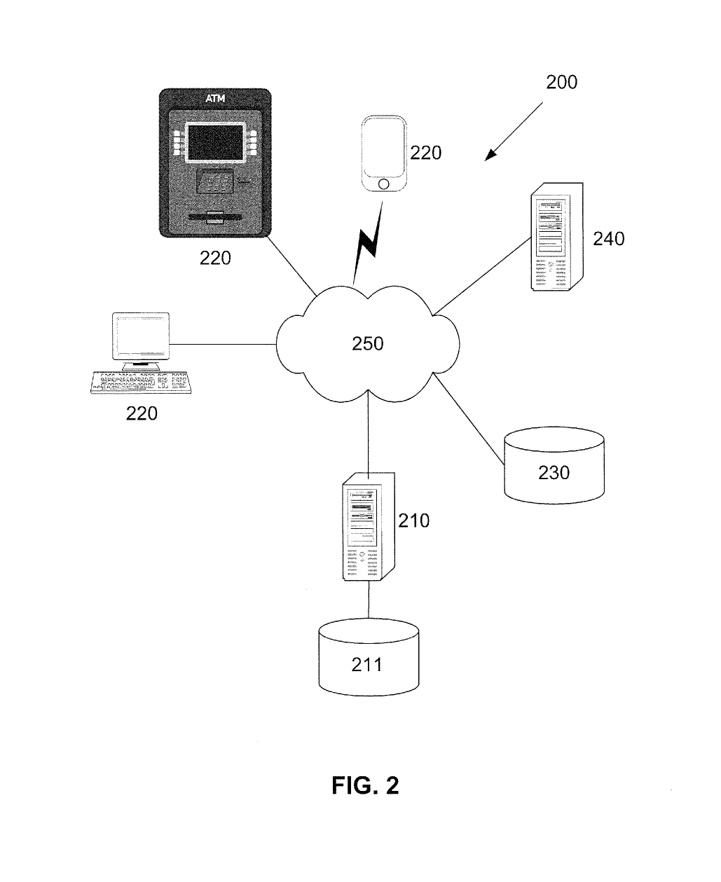

An example of a system for transferring funds between a user and a beneficiary will now be described with reference to FIG. 2.

In this example, the system 200 includes at least one electronic processing device, for example a user or payer bank processing device such as a server 210 in communication with one or more client devices 220 via one or more communication networks 250. The client devices 220 may include, for example, mobile phones, portable computers, tablet computers, and terminals such as automated teller machines (ATMs), POS devices and the like. The server 210 is also in communication via the communications network 250 with a national identifier data store 230 that stores an indication of national identifiers for at least one issuing country and a beneficiary bank processing device 240 such as computer system, server or the like. The server 210 is also in communication with a local format information data store 211 containing format information indicative of a format of national identifiers associated with a plurality of different issuing countries.

In practice, the system 200 will include multiple client devices 220 in numerous geographic locations around a country or region in communication with the server 210.

The communications network 250 can be of any appropriate form, such as the Internet and/or a number of local area networks (LANs) and provides onward connectivity to one or more client devices 220, the beneficiary bank processing device 240, the national identifier data store 230 and the server 210, which is in turn coupled to the format information data store 211. It will be appreciated that this configuration is for the purpose of example only, and in practice the various devices and data stores can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like.

In one example, the server 210 is adapted to receive and process funds transfer requests, including communication with data stores 211, 230 and bank processing devices 240 as appropriate for the purposes of validating beneficiary identifiers and obtaining beneficiary bank and account information. The server 210 may additionally be adapted to generate representations to be displayed to the user as required, with these being provided to the client devices 220 as required. Whilst the server 210 is a shown as a single entity, it will be appreciated that the server 210 can be distributed over a number of geographically separate locations, for example by using processing systems and/or databases that are provided as part of a cloud based environment. However, the above described arrangement is not essential and other suitable configurations could be used.

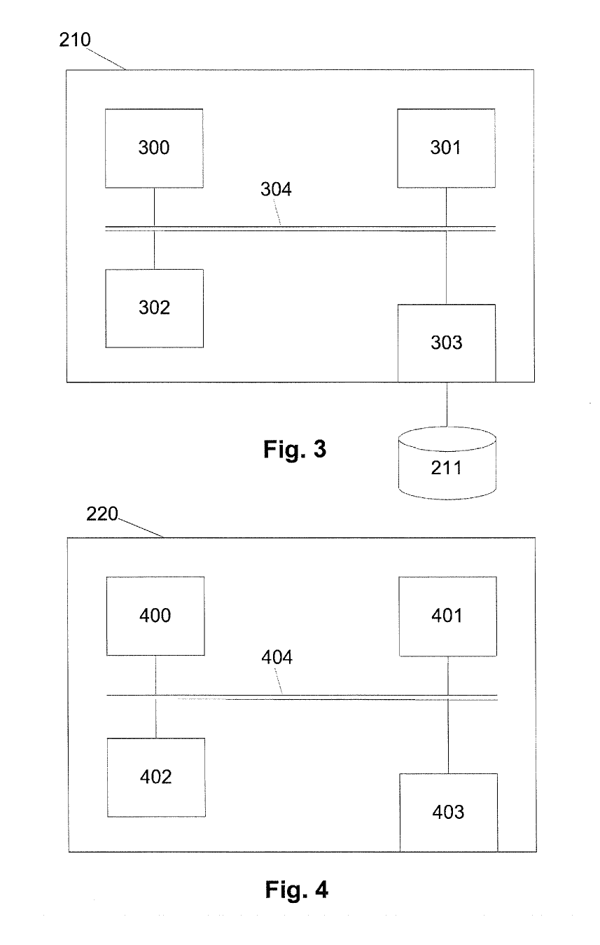

An example of a suitable server 210 is shown in FIG. 3. In this example, the server 210 includes at least one microprocessor 300, a memory 301, an optional input/output device 302, such as a keyboard and/or display, and an external interface 303, interconnected via a bus 304 as shown. In this example the external interface 303 can be utilised for connecting the server 210 to peripheral devices, such as the communications networks 250, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to allow the required processes to be performed, including communicating with the client devices 220, data stores 211, 230, beneficiary bank processing devices 240 and a payment gateway, and generating webpages (for example including internet banking webpages), or graphical user interfaces to be displayed on ATMs or like terminals. The applications software may include one or more software modules, and may be executed in a suitable execution environment, such as an operating system environment, or the like.

Accordingly, it will be appreciated that the server 210 may be formed from any suitable processing system, such as a suitably programmed computer system, PC, web server, network server, or the like. In one particular example, the server 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the client device 220 includes at least one microprocessor 400, a memory 401, an input/output device 402, such as a keyboard and/or display, and an external interface 403, interconnected via a bus 404 as shown. In this example the external interface 403 can be utilised for connecting the client device 230 to peripheral devices, such as the communications networks 240, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the server 210, for example to submit a funds transfer request via a graphical user interface displayed on the client device 220. The applications software may include one or more software modules, and may be executed in a suitable execution environment, such as an operating system environment, or the like.

Accordingly, it will be appreciated that the client devices 220 may be formed from any suitable processing system, such as a suitably programmed PC, Internet terminal, lap-top, or hand-held PC, and in one preferred example is either a terminal such as an ATM, tablet, smart phone, or the like. Thus, in one example, the client device 220 is a standard processing system such as an Intel Architecture based processing system, which executes software applications stored on non-volatile (e.g., hard disk) storage, although this is not essential. However, it will also be understood that the client devices 220 can be any electronic processing device such as a microprocessor, microchip processor, logic gate configuration, firmware optionally associated with implementing logic such as an FPGA (Field Programmable Gate Array), or any other electronic device, system or arrangement.

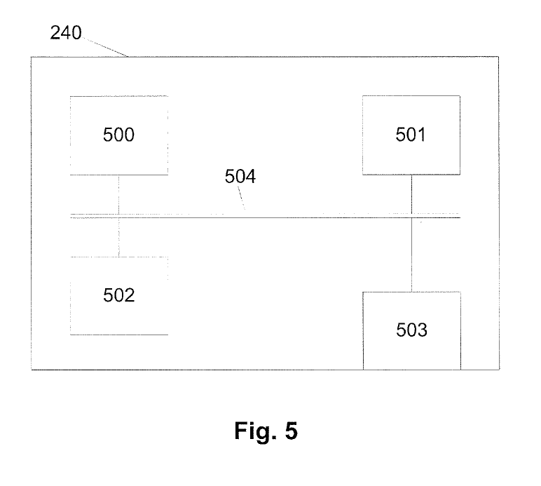

As shown in FIG. 5, in one example, the beneficiary bank processing device 240 includes at least one microprocessor 500, a memory 501, an input/output device 502, such as a keyboard and/or display, and an external interface 503, interconnected via a bus 504 as shown. In this example the external interface 503 can be utilised for connecting the bank processing device 240 to peripheral devices, such as the communications networks 250, databases, other storage devices, or the like. Although a single external interface 503 is shown, this is for the purpose of example only, and in practice multiple interfaces using various methods (e.g. Ethernet, serial, USB, wireless or the like) may be provided.

In use, the microprocessor 500 executes instructions in the form of applications software stored in the memory 501 to allow communication with the server 210, for example to receive a request to provide beneficiary account information, retrieve the beneficiary account information associated with the beneficiary identifier and to provide the beneficiary account information to the server 210.

Accordingly, it will be appreciated that the bank processing device 240 may be formed from any suitable processing system, such as a suitably programmed computer system, PC, web server, network server, or the like. Thus, in one example, the bank processing device 240 is a standard processing system such as an Intel Architecture based processing system, which executes software applications stored on non-volatile (e.g., hard disk) storage, although this is not essential. However, it will also be understood that the bank processing device 240 can be any electronic processing device such as a microprocessor, microchip processor, logic gate configuration, firmware optionally associated with implementing logic such as an FPGA (Field Programmable Gate Array), or any other electronic device, system or arrangement.

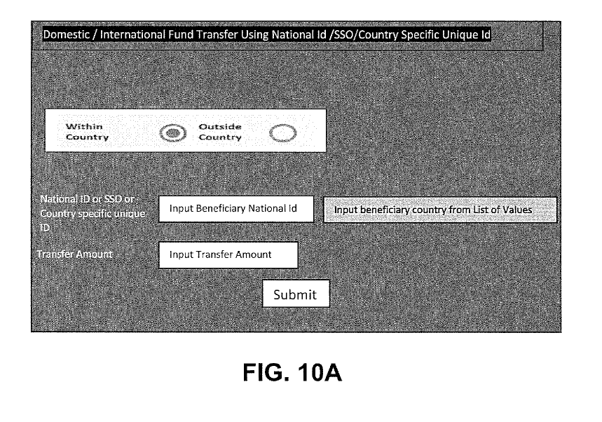

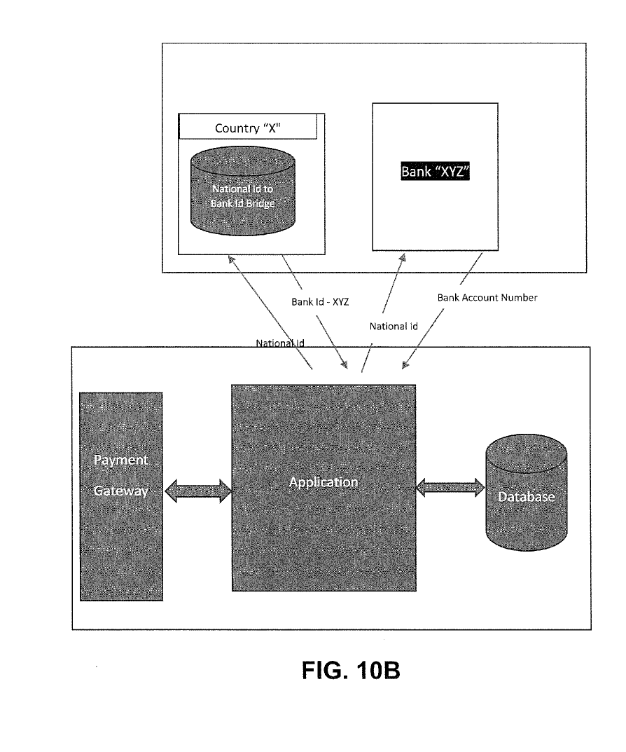

Examples of the operation of the system for transferring funds between a user and a beneficiary will now be described in further detail. For the purpose of these examples it will also be assumed that users interact with the system via a GUI (Graphical User Interface), or the like displayed on the client device 220, which may be generated by a local application, or hosted by the server 210 and displayed via a suitable application, such as a web browser or the like, executing on the client device 230. An example of front end GUI is provided in FIG. 10A.

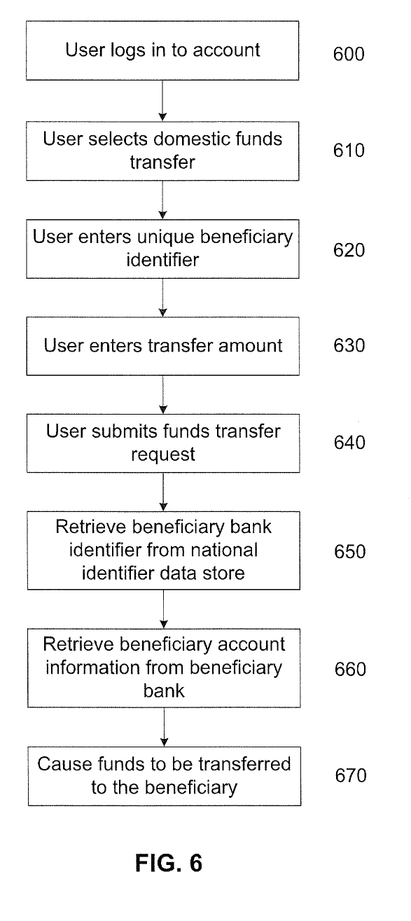

An example of a method for a domestic transfer of funds between a user and a beneficiary will now be described with reference to FIG. 6.

In this example, at step 600 the user logs in to their bank account. This may be achieved in any appropriate manner. In one example, the user may access their account via an ATM or similar terminal by inserting or tapping a payment card which is read by the terminal. Alternatively, the user may access their account via internet banking on a mobile device or desktop computer by entering their account details. If the user has a digital payment wallet, then the user may enter their login credentials to access their wallet.

After successfully logging in to their account, a GUI is displayed to the user for receiving user input and at step 610, the user selects the option of a domestic funds transfer.

At step 620, the user enters a unique beneficiary identifier which as previously described may be comprised of alphanumeric characters or alternatively may include some biometric information such as an image of the beneficiary that may be scanned by a reader connected to or integrated with the client device 220. The beneficiary identifier, including any necessary biometric information will typically have been provided to the user from the beneficiary and will represent a unique identifier for the individual issued by their country of citizenship.

At step 630, the user enters a funds transfer amount representing the amount of money to be transferred to the beneficiary and at step 640 the user submits the funds transfer request.

The funds transfer request is typically sent through a payment gateway to the server 210 which parses the request. At step 650, the server 210 retrieves the beneficiary bank identifier from the national identifier data store 230 using the beneficiary identifier. At step 660, the server 210 retrieves the beneficiary account information from the beneficiary bank processing device 240 which is identified in accordance with the bank identifier retrieved from the national identifier data store 230. The bank processing device 240 responds to the request from the server 210 to provide the beneficiary account information including the bank account number and any other required bank information such as branch ID.

At step 670, the server 210 then provides the beneficiary account information to the payment gateway to cause the funds to be transferred to the beneficiary in accordance with standard protocols for domestic transfer of funds. The user account is then debited the transfer amount and any applicable fees and the beneficiary account is credited with the transfer amount.

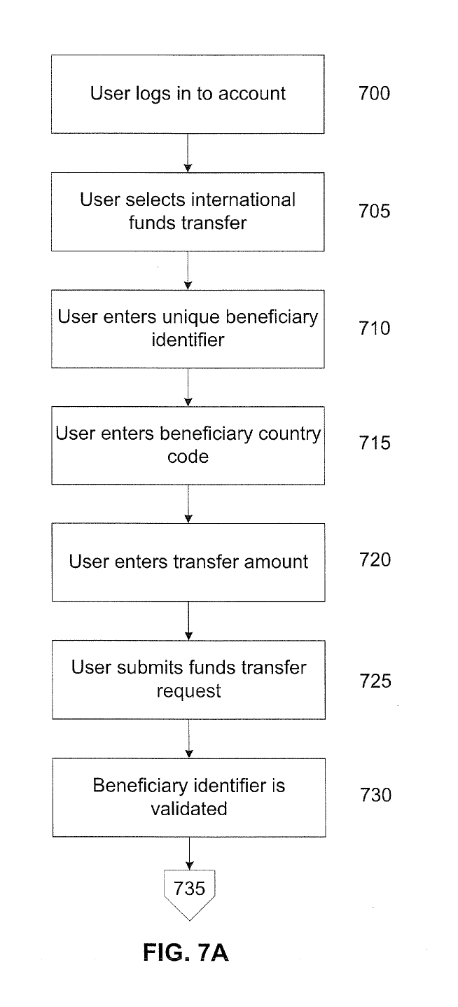

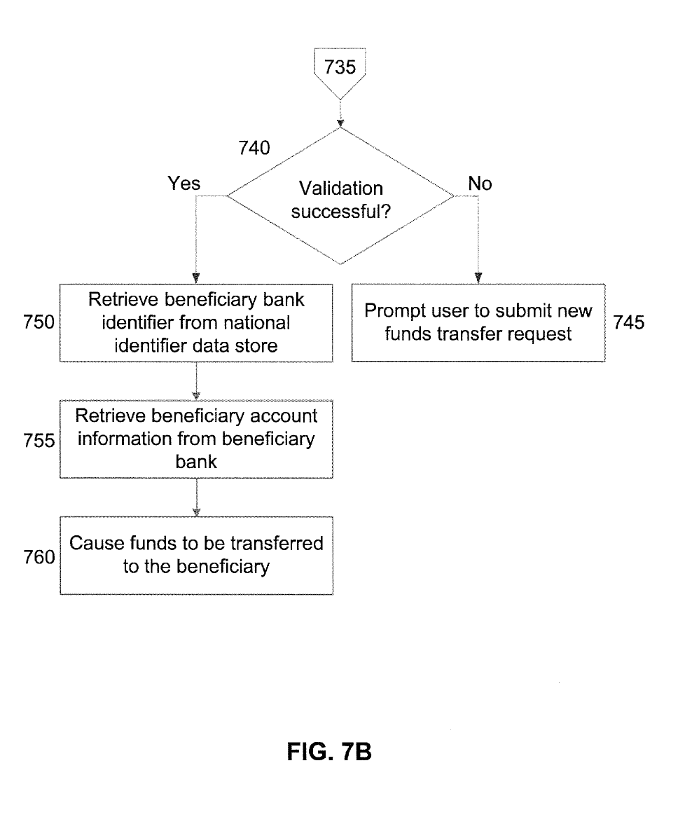

An example of a method for an international transfer of funds or remittance between a user and a beneficiary will now be described with reference to FIGS. 7A to 7B.

In this example, at step 700 the user logs in to their bank account in any appropriate manner as previous described with respect to the previous example.

After successfully logging in to their account, a GUI is displayed to the user for receiving user input and at step 705, the user selects the option of an international funds transfer.

At step 710, the user enters a unique beneficiary identifier as previously described and at step 715 the user enters a beneficiary country code, identifier or the like which is indicative of the issuing country of the unique beneficiary identifier. In one example, the country code is selected from a pick list provided to the user.

At step 720, the user enters a funds transfer amount representing the amount of money to be transferred to the beneficiary and at step 725 the user submits the funds transfer request.

The funds transfer request is typically sent through a payment gateway to the server 210 which parses the request. At step 730 the beneficiary identifier is validated to ensure that the beneficiary identifier and country code combination are valid. In other words, the validation determines whether the beneficiary identifier belongs to the country selected by the user or whether there is an error or mismatch. The validation process will be discussed in further detail below.

At step 740, the server 210 determines whether the validation was successful (i.e. the beneficiary identifier is consistent with national identifiers from the country associated with the country code selected by the user). If validation is not successful, then at step 745, the user will be prompted to submit a new funds transfer request, which will typically involve at least entering the beneficiary identifier and country code again.

If validation was successful, then at step 750 the server 210 retrieves the beneficiary bank identifier from the national identifier data store 230 using the beneficiary identifier. At step 755, the server 210 retrieves the beneficiary account information from the beneficiary bank processing device 240 which is identified in accordance with the bank identifier retrieved from the national identifier data store 230. The bank processing device 240 responds to the request from the server 210 to provide the beneficiary account information including the bank account number and any other required bank information such as branch ID.

At step 760, the server 210 then provides the beneficiary account information to the payment gateway to cause the funds to be transferred to the beneficiary in accordance with standard protocols for international funds transfer or remittance. The user account is then debited the transfer amount and any applicable fees and the beneficiary account is credited with the transfer amount.

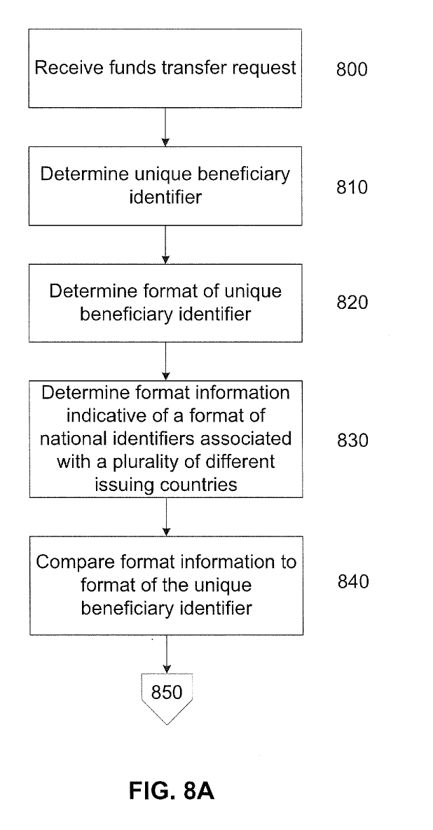

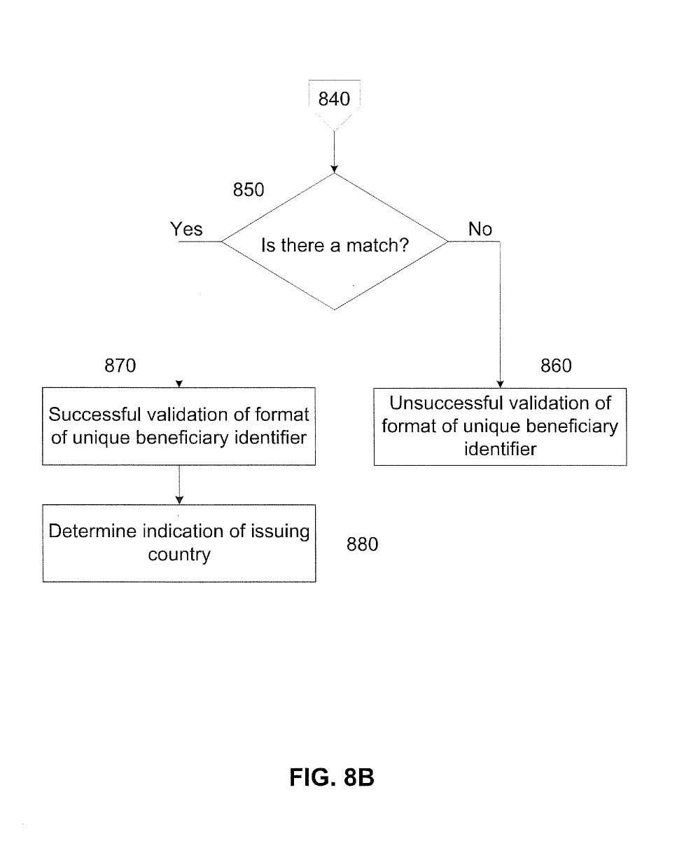

An example of a method of validating a format of a unique beneficiary identifier will now be described with reference to FIGS. 8A to 8B.

In this example, at step 800 the server 210 receives a funds transfer request from a client device 220 of the user, typically via a payment gateway or the like. It is assumed that the funds transfer request is an international funds transfer request and that the user has not provided an indication of the issuing country.

At step 810, the server 210 determines the unique beneficiary identifier which is provided by the user in the funds transfer request. A format of the unique beneficiary identifier is determined at step 820. For example, the server may determine particular parameters of the identifier including the number of alphanumeric characters including numeric digits and letters and their relative positions with respect to each other.

At step 830, the server 210 then queries the format information data store 211 to determine format information indicative of a format of national identifiers associated with a plurality of different issuing countries. The determined format information is then compared with the format of the unique beneficiary identifier at step 840. At step 850, the server 210 determines whether there has been a match. If no match is found, the format of the beneficiary identifier was entered incorrectly which results in unsuccessful validation at step 860.

If a match is found, then the validation of the format of the unique beneficiary identifier is determined to be successful at step 870. An indication of the issuing country of the beneficiary identifier can then be determined at step 880. The indication of the issuing country is determined by identifying the country having the same format of national identifier as the beneficiary identifier.

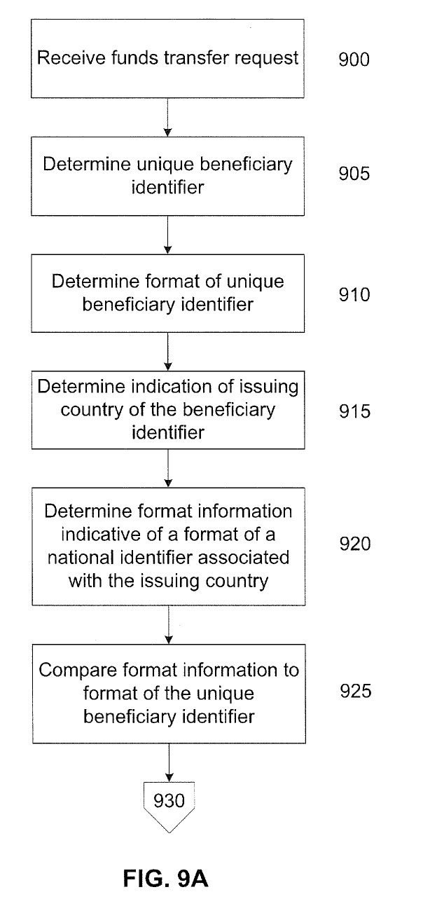

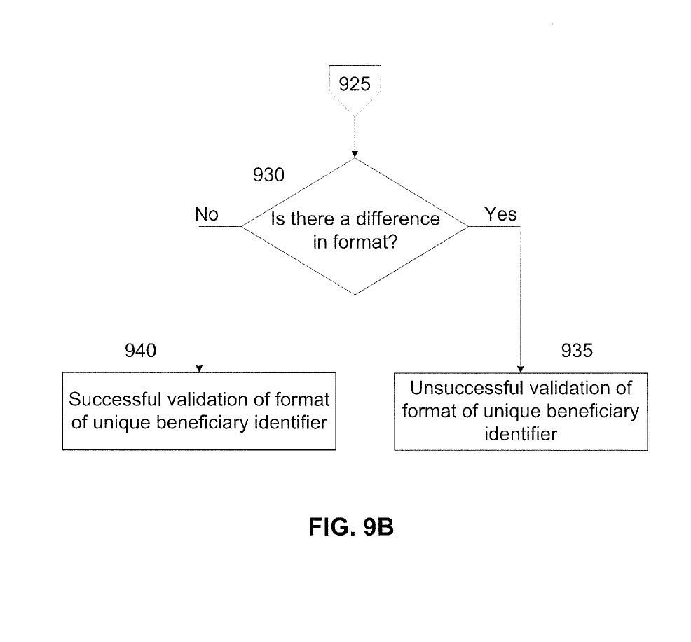

A further example of a method of validating a format of a unique beneficiary identifier will now be described with reference to FIGS. 9A to 9B.

In this example, at step 900 the server 210 receives a funds transfer request from a client device 220 of the user, typically via a payment gateway or the like. It is again assumed that the funds transfer request is an international funds transfer request, however in this example, an indication of the issuing country was provided by the user in the funds transfer request.

At step 905, the server 210 determines the unique beneficiary identifier which is provided by the user in the funds transfer request. A format of the unique beneficiary identifier is determined at step 910. For example, the server may determine particular parameters of the identifier including the number of alphanumeric characters including numeric digits and letters and their relative positions with respect to each other.

At step 915, the server 210 determines an indication of the issuing country of the beneficiary identifier in accordance with the input provided by the user in the funds transfer request.

At step 920, the server 210 then queries the format information data store 211 to determine format information indicative of a format of a national identifier associated with the issuing country selected by the user. The determined format information is then compared with the format of the unique beneficiary identifier at step 925. At step 930, the server 210 then determines whether there is a difference in format. If there is a difference, either the format of the beneficiary identifier was entered incorrectly or the wrong country code was provided which results in unsuccessful validation at step 935.

If there is no difference in format, then the validation of the format of the unique beneficiary identifier is determined to be successful at step 940 and the process then continues as previously described.

An example of a system for transferring funds between a user and a beneficiary showing dataflow to and from an application executing on a payer bank processing device is illustrated in FIG. 10B.

In this example, the application is configured to receive a funds transfer request from a client device via a payment gateway and to send information back to the payment gateway, including for example beneficiary account information. The application is coupled to a database for storing format information of national identifiers associated with a plurality of issuing countries. The application is further configured to communicate with a country specific national ID database which returns a beneficiary bank ID-“XYZ” in response to a request including the beneficiary national ID. The application is further configured to communicate with a beneficiary bank “XYZ” which returns a beneficiary bank account number in response to a request including the beneficiary national ID.

In any of the above described examples, the beneficiary identifier may additionally be encrypted when being transferred between the various devices for additional security in the transaction.

Accordingly, it will be appreciated that in at least one example the above described method and system provides a simple and convenient way to transfer funds both locally and internationally between a user and a beneficiary through use of a unique identifier associated with the beneficiary. This standardizes the transfer process and removes the need to ascertain and remember the various details that are currently required to transfer funds between a user and a beneficiary. By simplifying the process, a better user experience will be provided and the likelihood of transactions failing due to incorrectly entered or insufficient beneficiary details will be reduced.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A method of transferring funds between a user and a beneficiary, the method including, in one or more electronic processing devices:
a) receiving a funds transfer request from a client device of the user, the funds transfer request being indicative of:
i) user account information indicative of a user account associated with the user;
ii) a unique beneficiary identifier, the unique beneficiary identifier being a national identifier issued to the beneficiary by an issuing country; and,
iii) an amount of funds to be transferred to the beneficiary;
b) determining an indication of the issuing country;
c) using the unique beneficiary identifier and indication of the issuing country to retrieve beneficiary account information indicative of a beneficiary account associated with the beneficiary; and,
d) causing the funds to be transferred between the user account and the beneficiary account using the user account information and the beneficiary account information.

2) The method according to claim 1, wherein the indication of the issuing country is determined from at least one of:
a) a format of the unique beneficiary identifier; and,
b) input received from the user.

3) The method according to claim 2, wherein the one or more electronic processing devices communicate with a format information data store that stores format information indicative of a format of national identifiers associated with a plurality of different issuing countries.

4) The method according to claim 3, wherein the one or more electronic processing devices determine the indication of the issuing country associated with the unique beneficiary identifier by comparing the format of the unique beneficiary identifier with the format information.

5) The method according to claim 1, wherein the method further includes:
a) validating a format of the unique beneficiary identifier using format information determined at least partially in accordance with the indication of the issuing country and,
b) in response to successful validation, retrieving the beneficiary account information.

6) The method according to claim 5, wherein the step of validation includes:
a) using the indication of the issuing country to determine format information indicative of a format of a national identifier associated with the issuing country; and,
b) comparing the determined format information with the format of the unique beneficiary identifier.

7) The method according to claim 6, wherein the format information is retrieved from a local format information data store.

8) The method according to claim 1, wherein the one or more electronic processing devices use the unique beneficiary identifier to retrieve an associated beneficiary bank identifier from a national identifier data store storing an indication of national identifiers for at least one issuing country.

9) The method according to claim 8, wherein the national identifier data store is a remote data store.

10) The method according to claim 8, wherein the one or more electronic processing devices retrieve the beneficiary account information using the unique beneficiary identifier and the beneficiary bank identifier.

11) The method according to claim 10, wherein the beneficiary account information is retrieved from a bank processing device associated with the beneficiary bank identifier.

12) The method according to claim 11, wherein the one or more electronic processing devices:
a) transfer an account information request to the bank processing device using the beneficiary bank identifier, the account information request being indicative of the unique beneficiary identifier; and,
b) receive the beneficiary account information from the bank processing device.

13) The method according to claim 11, wherein the step of causing the funds to be transferred between the user account and the beneficiary account includes providing the user account information and the beneficiary account information to a payment gateway for processing of the funds transfer.

14) The method according to claim 1, wherein the funds transfer request is selected by a user from one of:
a) domestic; and,
b) international.

15) A method of transferring funds between a user and a beneficiary, the method including, in one or more electronic processing devices:
a) receiving a funds transfer request from a client device of the user, the funds transfer request being indicative of:
i) user account information indicative of a user account associated with the user;
ii) a unique beneficiary identifier, the unique beneficiary identifier being a national identifier issued to the beneficiary by an issuing country;
iii) an issuing country of the unique beneficiary identifier; and,
iv) an amount of funds to be transferred to the beneficiary;
b) validating a format of the unique beneficiary identifier using format information determined at least partially in accordance with an indication of the issuing country;
c) in response to successful validation, using the unique beneficiary identifier to retrieve beneficiary account information indicative of a beneficiary account associated with the beneficiary; and,
d) causing the funds to be transferred between the user account and the beneficiary account using the user account information and the beneficiary account information.

16) A system for transferring funds between a user and a beneficiary, the system including one or more electronic processing devices that:
a) receive a funds transfer request from a client device of the user, the funds transfer request being indicative of:
i) user account information indicative of a user account associated with the user;
ii) a unique beneficiary identifier, the unique beneficiary identifier being a national identifier issued to the beneficiary by an issuing country; and,
iii) an amount of funds to be transferred to the beneficiary;
b) determine an indication of the issuing country;
c) use the unique beneficiary identifier and indication of the issuing country to retrieve beneficiary account information indicative of a beneficiary account associated with the beneficiary; and,
d) cause the funds to be transferred between the user account and the beneficiary account using the user account information and the beneficiary account information.

17) The system according to claim 16, wherein the one or more electronic processing devices are in communication with one or more of:
a) a local format information data store that stores format information indicative of a format of national identifiers associated with a plurality of different issuing countries;
b) a remote national identifier data store associated with at least one issuing country that stores national identifiers and bank identifier information for a plurality of individuals; and,
c) a bank processing device that stores national identifiers and associated account information for at least some of the plurality of individuals.

18) The system according to claim 16, wherein the electronic processing device includes a computer-readable storage medium coupled to a processor, the computer-readable storage medium comprising code executable by the processor in the form of applications software.
